(19) United States
(12) Patent Application Publication
(10) Pub. No.: US 2009/0085890 A1
(43) Pub. Date: Apr. 2, 2009

(54) Touch Panel and Touch Panel Manufacturing Method

(75) Inventors: Atsushi SAITO, Narashino-shi (JP); Kohei Shimizu, Narashino-shi (JP); Koji Yoneda, Narashino-shi (JP)

Correspondence Address: CROWELL & MORING LLP;INTELLECTUAL PROPERTY GROUP, P.O. BOX 14300, WASHINGTON, DC, 20044-4300, US

(73) Assignee: SEIKO Precision Inc., Narashino-shi (JP)

(21) Appl. No.: 12/238,188

(22) Filed: Sep. 25, 2008

(30) Foreign Application Priority Data
Sep. 27, 2007 (JP) 2007-252402

(51) Int. Cl. G06F 3/045

(52) U.S. Cl. 345/174

(57) ABSTRACT

A first laminated body is formed by printing an electroluminescent layer that emits radiant light through the first substrate, as well as a first resistive film, upon a flexible and optically transparent first substrate including a principal surface that functions as an operable surface. A second laminated body is formed by printing a second resistive film upon a second substrate. A second resistive film is printed upon a second substrate. The laminated body and the second substrate are then unified such that the first resistive film and the second resistive film face each other and are spaced apart by a predetermined distance.

### BACKGROUND OF THE INVENTION

1. Field of the Invention

The present invention relates to a touch panel used as an input apparatus or similar component of various information processing equipment, and to a method for manufacturing a touch panel.

2. Description of the Related Art

Unexamined Japanese Patent Application KOKAI Publication No. H10-161116 and Unexamined Japanese Patent Application KOKAI Publication No. 2003-157148 describe a touch panel display apparatus made up of a touch panel, an LCD (liquid crystal display) panel, and a backlight stacked in this order. According to the above configuration, the touch panel and the backlight are separate modules, and for this reason assembly operations take time. Additionally, with the above configuration, the demand for thinner panels is not met. Furthermore, when viewed from the operable surface that is touched by the user, the LCD panel is disposed on the rear surface of the touch panel (hereinafter, the closer side when viewed from the operable surface will be referred to as the front surface, while the farther side will be referred to as the rear surface). Consequently, upon receiving light from the backlight, the LCD display passes through the touch panel before reaching the operable surface. As a result, there has been a problem regarding the visibility of the on-screen display.

### SUMMARY OF THE INVENTION

The present invention, being devised in order to solve problems such as the above, has as an object to provide a touch panel that has reduced manufacturing costs, is thinner, and has excellent visibility, as well as a method for manufacturing such a touch panel.

In order to achieve the above object, a touch panel according to the present invention comprises: a flexible, optically transparent first substrate that includes a principal (major) surface that functions as an operable surface; an electroluminescent layer, formed on the other principal surface of the first substrate, that emits radiant light through the first substrate; a touch panel, laminated to the electroluminescent layer, that is depressed as a result of flexure of the first substrate and the electroluminescent layer due to pressure on the operable surface of the first substrate, and subsequently outputs a signal for detecting the location of the pressure; and a second substrate laminated to the touch panel.

The touch panel may also be configured such that the light-emitting principal surface of the electroluminescent layer is disposed on the side of the other principal surface of the first substrate, and such that the touch panel also includes a first resistive film formed on the other principal surface of the electroluminescent layer, as well as a second resistive film, supported on the second substrate, that is disposed facing and spaced apart from the first resistive film.

In addition, the second substrate may also be fabricated from a flexible base material.

In addition, it is preferable for the electroluminescent layer to be fabricated from an electroluminescent layer that uses an inorganic fluorescent substance.

In addition, it is preferable for the touch panel to be fabricated from a resistive touch panel.

In addition, in order to achieve the above object, a touch panel manufacturing method according to the present invention includes the steps of: preparing a laminated body of a flexible first substrate and electroluminescent layer; forming a first resistive film for constructing a resistive touch panel on the electroluminescent layer; forming a second resistive film for constructing a resistive touch panel on a second substrate; and unifying the laminated body and the second substrate such that the first resistive film and the second resistive film face each other and are spaced apart by a predetermined distance.

In addition, the electroluminescent layer may also be formed by laminating a plurality of films onto a principal surface of the first substrate using a printing technique.

In addition, an organic conductive material may be printed onto a principal surface of the first substrate to form a transparent electrode, a mixed ink containing a mixture of a fluorescent substance and a binder may be printed onto the transparent electrode to form a luminescent layer, a mixed ink containing a mixture of barium titanate and a fluororesin binder may be printed onto the luminescent layer to form a dielectric layer, an organic conductive material may be printed onto the dielectric layer to form a rear surface electrode, and polyester may be printed onto the rear surface electrode to form a first insulating layer.

In addition, the first resistive film may also be formed upon the electroluminescent layer by printing.

In addition, the second resistive film may also be formed upon the second substrate by printing.

### BRIEF DESCRIPTION OF THE DRAWINGS

These objects and other objects and advantages of the present invention will be more apparent upon reading of the following detailed description and the accompanying drawings in which:

FIG. 1 is a cross-section diagram illustrating an overview of a touch panel according to an embodiment of the present invention;

FIG. 2 is a cross-section diagram illustrating a structure of the touch panel according to the embodiment of the present invention;

FIG. 3 is a perspective diagram illustrating a separated view of the touch panel according to the embodiment of the present invention;

FIGS. 4A and 4B are cross-section diagrams illustrating a separated view of the touch panel according to the embodiment of the present invention, wherein FIG. 4A is a cross-section diagram of a laminated body formed on the first substrate, and FIG. 4B is a cross-section diagram of a laminated body formed on the second substrate;

FIG. 5 is a cross-section diagram illustrating a state wherein the operable surface of the touch panel has been depressed;

FIGS. 6A and 6B are graphs illustrating the relationship between voltage applied to the touch panel and electrode distance, wherein FIG. 6A is a graph of X-axis distance versus voltage, and FIG. 6B is a graph of Y-axis distance versus voltage;

FIG. 7 is a cross-section diagram illustrating a touch panel according to another embodiment of the present invention;

FIG. 8 is a cross-section diagram illustrating a touch panel according to another embodiment of the present invention; and

FIG. 9 is a cross-section diagram illustrating a touch panel according to another embodiment of the present invention.

### DETAILED DESCRIPTION OF THE PREFERRED EMBODIMENT

Hereinafter, a touch panel according to an embodiment of the present invention will be described with reference to the accompanying drawings.

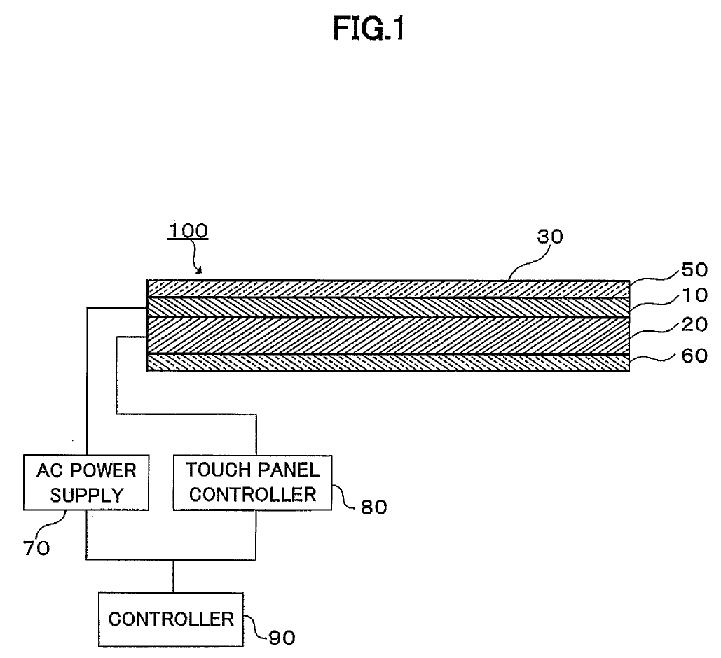

As shown in FIG. 1, a touch panel 100 with an illuminating function according to the present embodiment comprises a laminated body of the following layers: a first substrate 50 whose one principle (major) surface serving as an operable surface 30; an electroluminescent (hereinafter abbreviated as EL) layer 10; a touch panel 20; and a second substrate 60. These layers are laminated in the order given above. Coupled to the touch panel 100 are an AC (alternating current) power supply 70, a touch panel controller 80, and a controller 90.

Hereinafter, the configuration and operation of the touch panel 100 will be described.

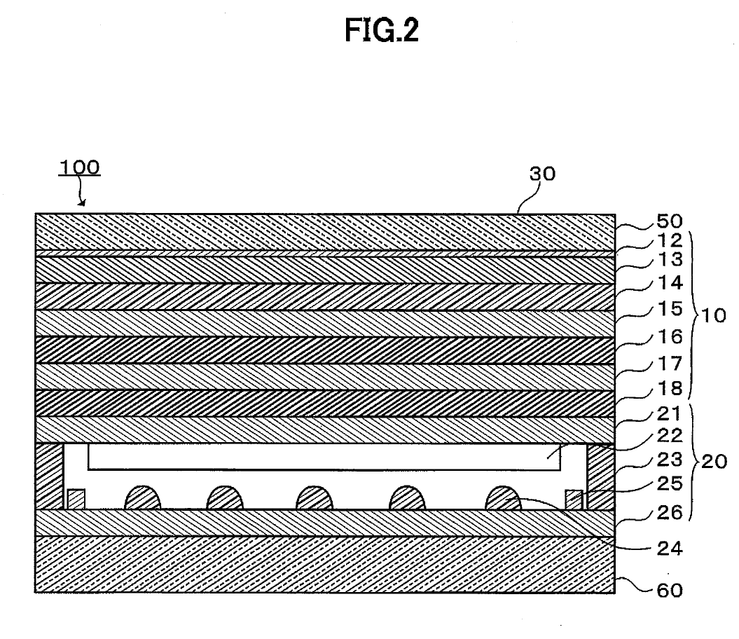

As shown in FIG. 2, the first substrate 50 includes, on one principal surface thereof, an operable surface 30 that is depressed in order to execute desired operations. The first substrate 50 is made from a material that is flexible enough to be easily flexed as a result of the operable surface 30 being depressed directly by a finger, a touch pen, or similar means. In addition, the first substrate 50 is made from a material that is able to optically transmit light emitted from the EL layer 10 disposed on the rear surface thereof For example, the first substrate 50 may be formed from PET (polyethylene terephthalate), PC (polycarbonate), or other transparent plastic film. The thickness of the first substrate 50 may be from 20 μm to 300 μm.

The EL layer 10 laminated to the rear surface of the first substrate 50 is made up of a transparent electrode 12, a luminescent layer 13, a dielectric layer 14, a rear surface electrode 15, a first insulating layer 16, a shield layer 17, and a second insulating layer 18

The transparent electrode 12 is formed of a conductive film which can transmit light emitted from the luminescent layer 13. The transparent electrode 12 may be formed by printing an organic conductive material such as PEDOT (polyethylene dioxythiophene), for example. The transparent electrode 12 may also be a conductive film of ITO (Indium Tin Oxide, or tin-doped indium oxide) formed by vapor deposition or sputtering.

The luminescent layer 13 is formed by printing a mixed ink containing a mixture of an inorganic fluorescent substance such as ZnS (zinc sulfide) with a binder such as a fluororesin binder.

The dielectric layer 14 provides insulation between the transparent electrode 12 and the rear surface electrode 15. The dielectric layer 14 is formed by printing a mixed ink of barium titanate to which a fluororesin binder has been added.

The rear surface electrode 15 is formed as a film by printing a carbon ink or an organic conductive material such as PEDOT. The rear surface electrode 15 need not be optically transparent.

The first insulating layer 16 provides insulation between the rear surface electrode and the shield layer 17. The first insulating layer 16 is formed by printing polyester.

The shield layer 17 functions as an electromagnetic radiation blocking layer between the EL layer 10 and the touch panel 20. In order to elicit such functionality, the shield layer 17 is formed from a highly conductive material such as PEDOT, for example.

The second insulating layer 18 provides insulation between the shield layer 17 and the first resistive film 21. The second insulating layer 18 is formed by printing polyester.

The touch panel 20 herein is a resistive touch panel. The touch panel 20 includes: a first resistive film 21; a second resistive film 26; a pair of first electrodes 22a and 22b disposed upon the first resistive film 21 (hereinafter, the pair of the first electrodes 22a and 22b will be referred to as 22 when no particular distinction is being made therebetween); a pair of second electrodes 25a and 25b disposed upon the second resistive film 26 (hereinafter, the pair of the second electrodes 25a and 25b will be referred to as 25 when no particular distinction is being made therebetween); ribs 23 that provide a predetermined amount of spacing between the first resistive film 21 and the second resistive film 26; and dot spacers 24 that prevent accidental contact between the first resistive film 21 and the second resistive film 26.

The first resistive film 21 and the second resistive film 26 are respectively fabricated from a flexible conductive film (such as PEDOT). The first resistive film 21 and the second resistive film 26 are disposed facing each other and spaced apart by a predetermined distance due to the ribs 23.

The ribs 23 are fabricated from an insulating resin such as an adhesive ink. The ribs 23 are disposed at the peripheral edges of the first resistive film 21 and the second resistive film 26 so as to maintain the predetermined amount of spacing between the first resistive film 21 and the second resistive film 26. Anything may be used for the ribs 23 so long as the spacing between the first resistive film 21 and the second resistive film 26 is maintained thereby. For example, double-sided adhesive tape may be used instead of adhesive ink.

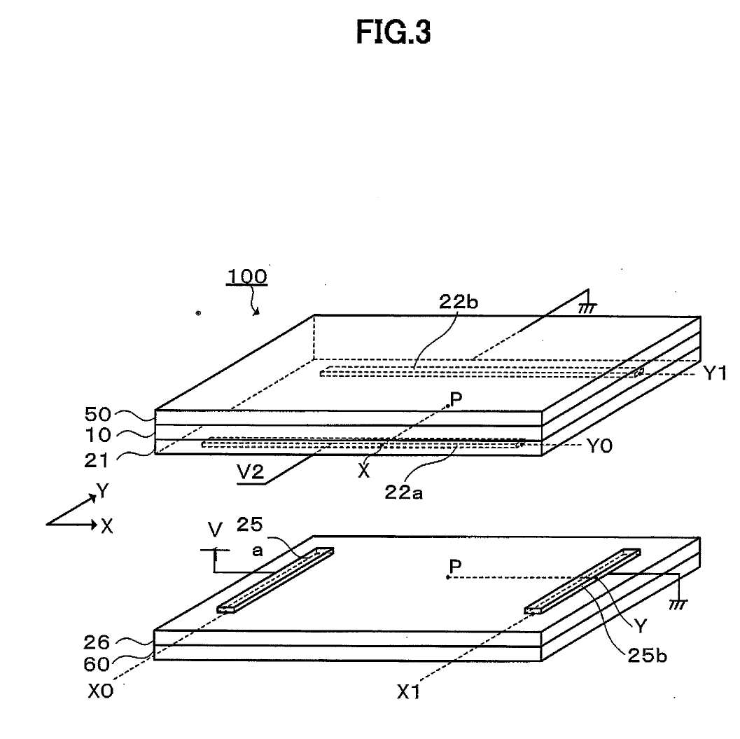

The pair of the first electrodes 22 and the pair of the second electrodes 25 are formed by using a conductive ink such as silver paste. As shown in FIG. 3, the pair of the first electrodes 22 is disposed in parallel near the edges of the first resistive film 21 along the X axis as viewed in the figure. Additionally, the pair of the second electrodes 25 is disposed in parallel near the edges of the second resistive film 26 along the Y axis.

The dot spacers 24 are disposed on one surface of the second resistive film 26 in a matrix configuration at a predetermined pitch. The dot spacers 24 prevent accidental contact between the first resistive film 21 and the second resistive film 26. The dot spacers 24 may have, for example, a diameter between 0.02 mm and 0.4 mm, a height between 0.01 mm and 0.03 mm, and be provided at a pitch approximately between 2 mm and 10 mm.

The second substrate 60 is disposed on the rearmost surface of the touch panel 20 and supports the entire touch panel 100. The second substrate 60 may be fabricated from glass or a material such as a flexible resin. By using a material such as a flexible resin for the second substrate 60, the touch panel 100 can be configured to be bendable.

A method for manufacturing the touch panel 100 having the configuration described above will now be described.

First, the first substrate 50 is prepared.

Next, an organic conductive material such as PEDOT is screen printed onto the first substrate 50 at a predetermined thickness. By subsequently drying this organic conductive material, the transparent electrode 12 is formed. The transparent electrode 12 may also be formed by ITO vapor deposition or by ITO sputtering.

Next, a mixed ink, made up of a fluorescent substance such as ZnS (zinc sulfide) to which a binder such as a fluororesin binder has been added, is screen printed onto the transparent electrode 12. By subsequently solidifying the mixed ink, the luminescent layer 13 is formed.

Next, a mixed ink containing a mixture of barium titanate and a fluororesin binder is screen printed onto the luminescent layer 13. By subsequently solidifying the mixed ink, the dielectric layer 14 is formed.

Next, an organic conductive material such as PEDOT is screen printed onto the dielectric layer 14. By subsequently drying this organic conductive material, the rear surface electrode 15 is formed.

Next, the first insulating layer 16 is formed by screen printing polyester onto the rear surface electrode 15.

Subsequently, an organic conductive material such as PEDOT is screen printed onto the first insulating layer 16. By subsequently drying this organic conductive material, the shield layer 17 is formed.

Next, the second insulating layer 18 is formed by screen printing polyester onto the shield layer 17.

Subsequently, an organic conductive material such as PEDOT is screen printed thinly onto the second insulating layer 18. By subsequently solidifying this organic conductive material, the first resistive film 21 is formed.

In addition, a conductive ink such as silver paste is screen printed at predetermined locations on the first resistive film 21. By subsequently solidifying this conductive ink, the pair of the first electrodes 22 are formed.

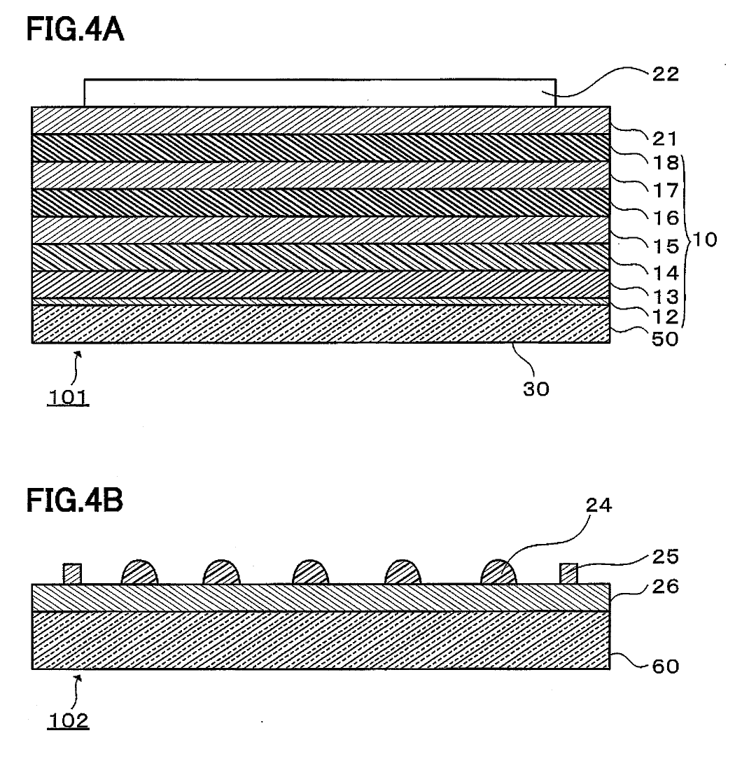

In this way, a plurality of layers are successively formed by printing, thereby forming an EL layer 10 upon the first substrate 50, as shown in FIG. 4A. Furthermore, a laminated body 101 is obtained as a result of the first resistive film 21 and the pair of the first electrodes 22 being formed upon the EL layer 10.

Meanwhile, the second substrate 60 is prepared, and an organic conductive material such as PEDOT is screen printed onto the second substrate 60 at a predetermined thickness. By subsequently drying this organic conductive material, the second resistive film 26 is formed. The second substrate 60 may be formed from plastic such as PET or PC, or from glass, ceramic, or similar material. The second substrate 60 may or may not be translucent.

Next, a conductive ink such as silver paste is screen printed at predetermined locations on the second resistive film 26. By subsequently solidifying this conductive ink, the pair of the second electrodes 25 are formed.

Subsequently, cylindrical bodies are printed onto the second resistive film 26 in a matrix configuration at a pitch between 2 mm and 10 mm. The cylindrical bodies are made from polyester and have a diameter between 0.02 mm and 0.4 mm as well as a height between 0.01 mm and 0.03 mm. With subsequent heating, these cylindrical bodies deform into hemispheres as a result of the surface tension of the polyester. By subsequently cooling these hemispheres the dot spacers 24 are formed.

In this way, a plurality of layers are successively formed by printing, and a laminated body 102 is obtained forming a portion of the touch panel 20 upon the second substrate 60, as shown in FIG. 4B.

Next, a hardening adhesive ink is printed onto the peripheral edges of the first resistive film 21 or the second resistive film 26, and the laminated body 101 illustrated in FIG. 4A and the laminated body 102 shown in FIG. 4B are joined facing each other. The adhesive ink subsequently hardens to form the ribs 23, and as a result the touch panel 100 is obtained. Anything may be used as the ribs 23 so long as the first resistive film 21 and the second resistive film 26 can be joined with a predetermined amount of spacing therebetween. For example, the first resistive film 21 and the second resistive film 26 may be joined using double-sided tape instead of adhesive ink.

Next, the operation of the touch panel 100 having the above configuration will be described.

First, when a primary power source (not shown in the drawings) is turned on, the controller 90 initiates the AC power supply 70 and the touch panel controller 80.

The AC power supply 70 applies an AC voltage such as 100 V at 400 Hz between the transparent electrode 12 and the rear surface electrode 15. As a result of the applied voltage, accelerated electrons inside the luminescent layer 13 collide with the atoms of the fluorescent substance. As a result of these collisions, the atoms of the fluorescent substance are excited. When returning to the ground state from the excited state, the atoms of the luminescent substance emit light.

Meanwhile, the touch panel controller 80 repeatedly conducts operations to apply a voltage V2 between the first electrodes 22a and 22b and a voltage V1 between the second electrodes 25a and 25b in an alternating manner. In addition, the touch panel controller 80 monitors the voltage between the first electrodes 22a and 22b and the second electrodes 25a and 25b when voltage is not being applied thereto.

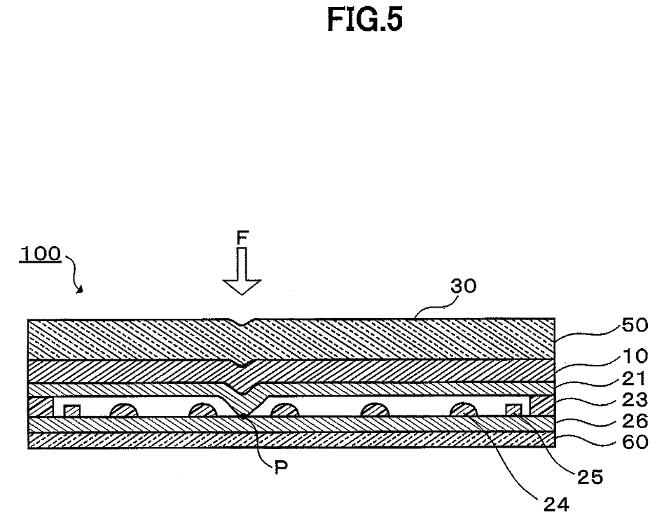

In this state, the flexible first substrate 50 and the EL layer 10 bend upon receiving a depressive force F due to a user's finger or a touch pen and incident on the operable surface 30, as shown in FIG. 5. As a result, the first resistive film 21 is depressed and contacts the second resistive film 26 at a contact point P.

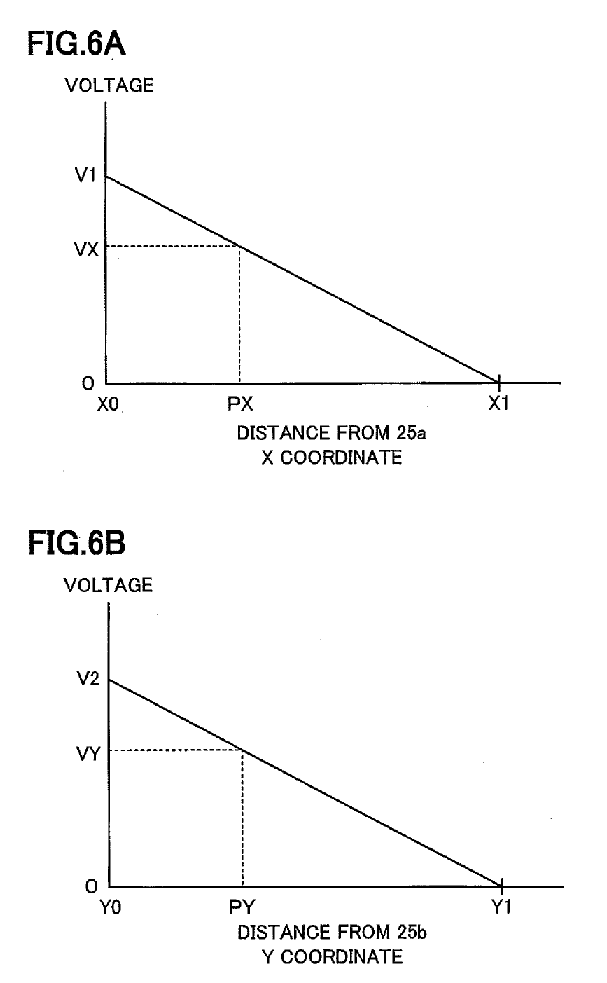

As shown in FIG. 6A, a linear relationship exists between the voltage V1 applied between the second electrodes 25a and 25b and the X coordinate of the contact point P. Similarly, as shown in FIG. 6B, a linear relationship exists between the voltage V2 applied between the first electrodes 22a and 22b and the Y coordinate of the contact point P.

By detecting a voltage VX arising between the first electrodes 22a and 22b while the voltage V1 is being applied between the second electrodes 25a and 25b, the X axis position PX of the contact point P can be determined. Similarly, by detecting a voltage VY arising between the second electrodes 25a and 25b while the voltage V2 is being applied between the first electrodes 22a and 22b, the Y axis position PY of the contact point P can be determined.

In this way, the touch panel controller 80 determines the depressed location by monitoring the voltages between the pair of the first electrodes 22 and between the pair of the second electrodes 25.

According to the embodiment described above, the touch panel 100 is obtained as a laminated body of the following: a flexible and optically transparent first substrate 50; an EL layer 10 that emits radiant light through the first substrate 50; a touch panel 20 that outputs voltage signals from the pair of the first electrodes 22 and the pair of the second electrodes 25 to a touch panel controller 80, wherein the voltage signals are used to detect a depressed location that has been depressed as a result of pressure that is incident on an operable surface 30 and transmitted through the first substrate 50 and the EL layer 10; and a second substrate 60.

In addition, as described with reference to FIGS. 4A and 4B, it is also possible to manufacture the touch panel 100 by first forming laminated bodies 101 and 102 by printing and subsequently laminating the laminated bodies 101 and 102 together. With this arrangement, assembly of the touch panel 100 is simple, and it becomes possible to lower costs.

In addition, the EL layer 10 and the first substrate 50 are disposed adjacent to each other. Consequently, the light emitted by the EL layer 10 reaches and radiates from the operable surface 30 without passing through the touch panel 20. For this reason, the touch panel 100 according to the present embodiment is able to realize a screen display that is not dull compared to that of touch panel display devices of the related art.

In addition, by forming laminated films between a flexible first substrate 50 and second substrate 60, the touch panel 100 can be configured in a thin and bendable form factor.

In addition, since a plurality of layers are formed by successive printings, a thin touch panel 100 can be fabricated.

The present invention is not limited to the embodiment described above, and that various modifications and applications are possible.

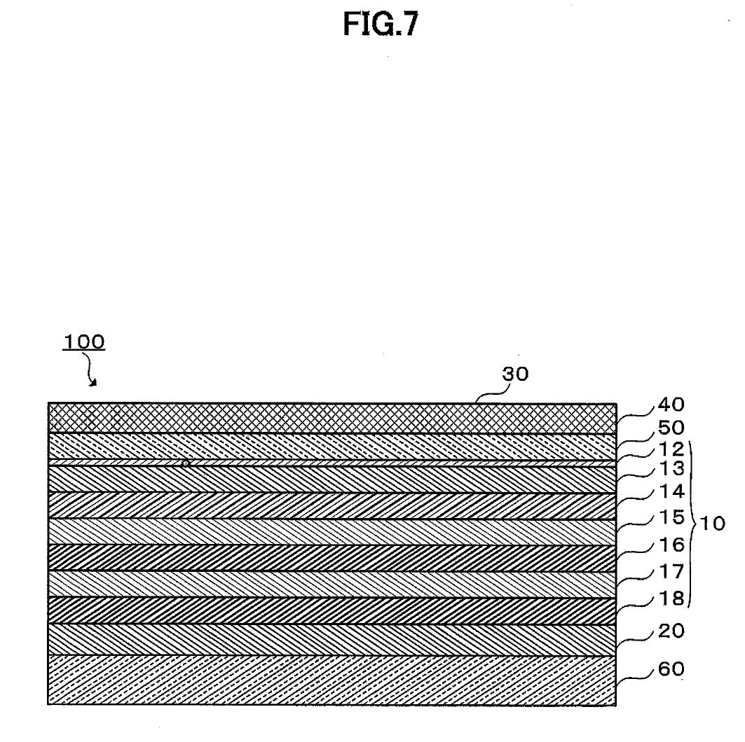

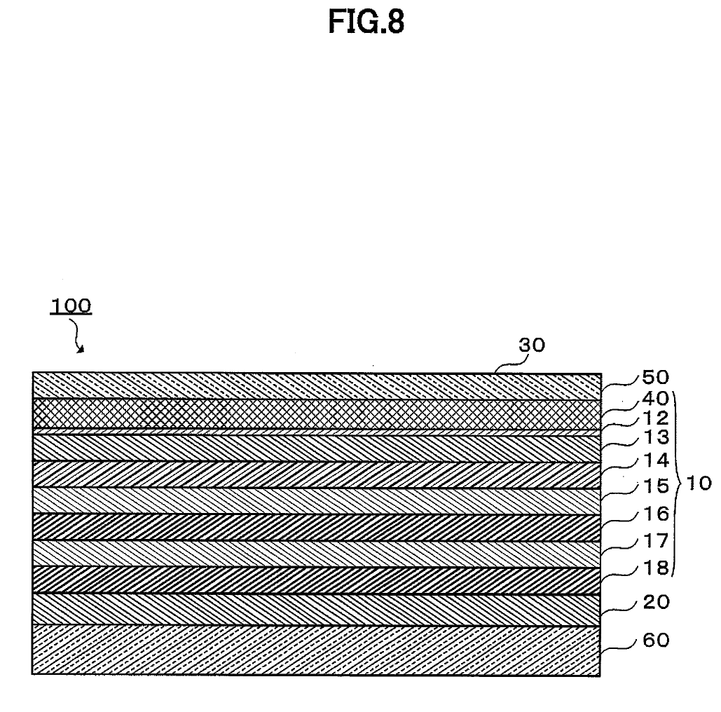

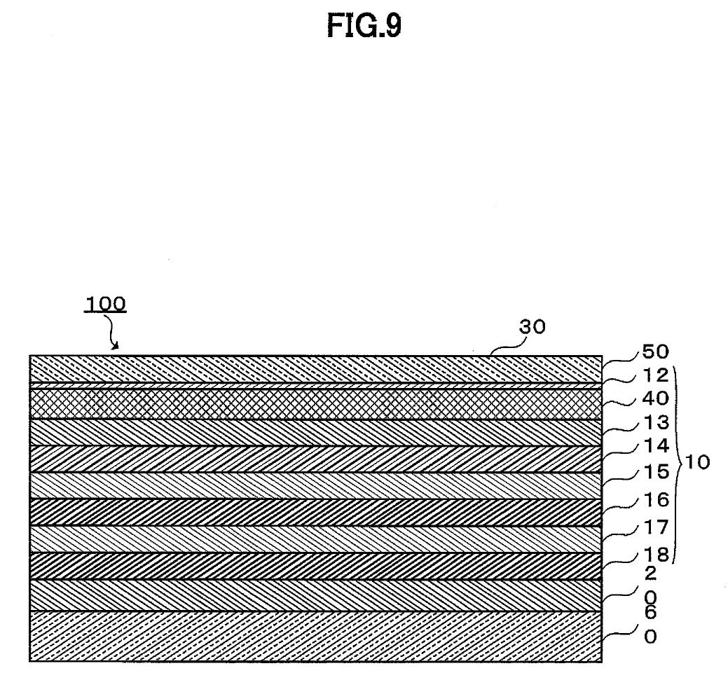

For example, a decorative layer may be disposed in the touch panel 100, thereby causing the decorative design of a decorative layer 40 to be displayed on the operable surface 30. FIG. 7 illustrates the case wherein the decorative layer 40 has been disposed as the foremost layer of the touch panel 100. FIG. 8 illustrates the case wherein the decorative layer 40 has been disposed on another principal surface (back surface) of the first substrate 50. FIG. 9 illustrates the case wherein the decorative layer 40 has been disposed on the transparent electrode 12.

In addition, in the embodiment described above, a laminated construction that includes a first insulating layer 16, a shield layer 17, and a second insulating layer 18 was described as shown in FIG. 2. However, the shield layer 17 may be omitted in the case where the electromagnetic noise between the EL layer 10 and the touch panel 20 is small enough to pose no problems in practice. In this case, the configuration made up of the first insulating layer 16, the shield layer 17, and the second insulating layer 18 may be replaced with a single insulating layer.

In addition, in the foregoing embodiment, although a touch panel that uses inorganic EL was described, a touch panel that uses organic EL may also be realized.

In addition, the foregoing embodiment was described for the case wherein a resistive touch panel is provided. However, the present invention is not limited thereto, so long as an EL layer is formed upon a first substrate and a touch panel is formed upon the EL layer. For example, configurations may also be realized wherein a touch panel such as a surface acoustic wave (ultrasonic) touch panel, a capacitive touch panel, or an infrared touch panel is formed upon the EL layer.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2007-252402 filed on Sep. 27, 2007 and including specification, claims, drawings and summary. The disclosure of the above Japanese Patent Application is incorporated herein by reference in its entirety.

What is claimed is:

1. A touch panel, comprising:
a flexible, optically transparent first substrate having a principal surface that functions as an operable surface;
an electroluminescent layer, formed on the other principal surface of the first substrate, that emits radiant light through the first substrate;
a touch panel, disposed laminated to the electroluminescent layer, that is depressed as a result of flexure of the first substrate and the electroluminescent layer due to pressure incident on the operable surface of the first substrate, and subsequently outputs a signal for detecting the location of the pressure; and
a second substrate laminated to the touch panel.

2. The touch panel according to claim 1, wherein
the light-emitting principal surface of the electroluminescent layer is disposed on the side of the other principal surface of the first substrate, and
the touch panel also includes both a first resistive film formed on the other principal surface of the electroluminescent layer, and a second resistive film, supported on the second substrate, that is disposed facing and spaced apart from the first resistive film.

3. The touch panel according to claim 1, wherein the second substrate is fabricated from a flexible base material.

4. The touch panel according to claim 1, wherein the electroluminescent layer uses an inorganic fluorescent substance.

5. The touch panel according to claim 1, wherein the touch panel is a resistive touch panel.

6. A touch panel manufacturing method, comprising the steps of:
preparing a laminated body of a flexible first substrate and an electroluminescent layer;
forming a first resistive film for constructing a resistive touch panel on the electroluminescent layer;
forming a second resistive film for constructing a resistive touch panel on a second substrate; and
unifying the laminated body and the second substrate such that the first resistive film and the second resistive film face each other and are spaced apart by a predetermined distance.

7. The touch panel manufacturing method according to claim 6, wherein the electroluminescent layer is formed by laminating a plurality of films onto a principal surface of the first substrate by using a printing technique.

8. The touch panel manufacturing method according to claim 7, wherein
an organic conductive material is printed onto a principal surface of the first substrate to form a transparent electrode,
a mixed ink containing a mixture of a fluorescent substance and a binder is printed onto the transparent electrode to form a luminescent layer,
a mixed ink containing a mixture of barium titanate and a fluororesin binder is printed onto the luminescent layer to form a dielectric layer,
an organic conductive material is printed onto the dielectric layer to form a rear surface electrode, and
polyester is printed onto the rear surface electrode to form a first insulating layer.

9. The touch panel manufacturing method according to claim 6, wherein the first resistive film is formed upon the electroluminescent layer by printing.

10. The touch panel manufacturing method according to claim 6, wherein the second resistive film is formed upon the second substrate by printing.
